(19) United States
(12) Patent Application Publication
(10) Pub. No.: US 2010/0272941 A1
(43) Pub. Date: Oct. 28, 2010

(54) DURABLE WATER- AND OIL- RESISTANT, BREATHABLE MICROPOROUS MEMBRANE

(75) Inventors: Srinivas Cherukupalli, Andhra Pradesh, OR (US); Steve Gerts, Corvallis, OR (US); Daniel Lee, Lebanon, OR (US); Cory Rogers, Eugene, OR (US); Richard W. Pekala, Corvallis, OR (US)

Correspondence Address: STOEL RIVES LLP - PDX, 900 SW FIFTH AVENUE, SUITE 2600, PORTLAND, OR, 97204-1268, US

(73) Assignee: Entek Membranes LLC, Lebanon, OR (US)

(21) Appl. No.: 12/743,019

(22) PCT Filed: Nov. 15, 2008
(86) PCT No.: PCT/US08/83710

§ 371 Date: Jul. 13, 2010

Related U.S. Application Data
(60) Provisional application No. 60/988,376, filed on Nov. 15, 2007.

(51) Int. Cl. B32B 3/26; B32B 3/10

(52) U.S. Cl. 428/41.3; 428/315.5; 428/195.1; 428/300.7

(57) ABSTRACT

A durable water- and oil-resistant, breathable thin microporous membrane (90) exhibits good hand, feel, and drape. The structure of microporous membrane is a thin polymer matrix that includes a polyolefin material having a bulk region (186) between first and second major surfaces (184, 194). The bulk region includes multiple interconnecting micropores (87) extending between the surfaces to form a polyolefin membrane (170) that exhibits inherent hydrophobicity and moisture vapor transmission properties. An applied fluorochemical treatment (92) imparts oleophobicity to the polyolefin membrane by imparting a lower surface energy to polyolefin membrane to provide oil and surfactant resistance, and to maintain moisture vapor transmission through the microporous structure. Preferred embodiments of microporous membrane also include an inorganic filler material such as calcium carbonate. In one application, the fluorochemically treated microporous polyolefin membrane is bonded to a fabric material to form a fabric laminate with optimized permeability characteristics.

### COPYRIGHT NOTICE

© 2008 Entek Membranes LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

The present disclosure generally relates to a microporous, polyolefin membrane and, more particularly, to a breathable, hydrophobic microporous membrane that is rendered oleophobic and resistant to contaminants by fluorochemical treatment of the membrane.

### BACKGROUND INFORMATION

Microporous membranes are typically used in a wide variety of applications ranging from fabric laminates (also known as textile laminates) in uniforms, workwear, active wear, and protective clothing; industrial applications, such as filtration and battery separators; medical uses, such as surgical drapes or vent filters for intravenous fluids; and military applications such as tents and tarps. A microporous membrane that is highly breathable, i.e., allows an unhindered passage of water vapor, but which is resistant to water in a liquid state, oil, and other contaminants, is particularly advantageous in textile fabric applications. Conventional membranes used for textile fabrics are formed primarily of expanded polytetrafluoroethylene, ePTFE, which is microporous and is laminated to at least one other material such as a shell fabric. In some cases, an inner liner is also attached to the skin side of the membrane.

Despite their relative success in the marketplace, ePTFE membranes are costly and inherently suffer from deficiencies in ease of handling, environmental friendliness, strength, elasticity, and adhesion. These membranes also absorb body oils present in perspiration or detergent contaminants found in washing residues, which then tend to decrease resistance to liquid penetration. Therefore, to maintain water resistance, ePTFE membranes are typically coated with either a monolithic polyurethane (PU) layer, as described in U.S. Pat. No. 4,194,041, or a fluorochemical treatment that coats the pore structure, as described in U.S. Pat. No. 6,854,603. These two approaches have also been combined, as described in U.S. Pat. No. 6,261,678, in which a monolithic PU layer is coated on a fluorochemical treated ePTFE film. The latter approach can lead only to greatly increased costs and is not a commercially viable alternative.

An ePTFE membrane layered with monolithic PU is generally resistant to body oils and other contaminants primarily because of the nonporous PU layer, there is no open pathway for contaminants to pass through the PU layer. The coating must be sufficiently thick for this purpose but not so thick that it decreases flexibility. Depending on its thickness and composition, the PU layer has adequate ability for water or moisture to absorb and diffuse from the side of the fabric laminate facing the body and transmit moisture vapor to the side of the fabric laminate facing the atmosphere, thereby maintaining breathability.

Coating or extruding substrates with fluorochemical compositions is well known to skilled persons as an effective way to impart water- and oil-resistance. For example, compositions include perfluoroalkyl acrylates or methacrylate co-polymers (U.S. Pat. Nos. 6,854,603 and 6,261,678), fluorinated monomers that are later polymerized (U.S. Pat. Nos. 5,217,802 and 5,286,382), fluorinated urethanes (U.S. Pat. Nos. 5,286,279; 6,803,109; and 7,078,454), perfluoro-2,2-dimethyl-1,3-dioxole for extrusion (U.S. Pat. No. 5,116,650). These compounds are capable of repelling water and oil by reducing the surface energy of the coated membrane to a value below that of the surface tension of a wetting liquid.

U.S. Pat. No. 4,539,255 details the use of a non-porous polyamino acid modified polyurethane film that is laminated to a fabric. A non-porous film is designed to keep out contaminants that can reduce the ability of the film to be waterproof. However, such an approach requires that the film effectively transmit water or water vapor through a slow absorption and diffusion process. This results in a saturated and clammy feeling to the user, which is also true for thick nonporous PU coatings typically used on ePTFE membranes. U.S. Pat. No. 4,493,870 also describes a water-vapor permeable, waterproof fabric comprising a non-porous film formed from a polyetherester elastomer (PEE) that is laminated on the surface of a substrate fabric. U.S. Pat. No. 6,521,552 describes a coating of two layers of PEE directly on the fabric. The layers also have different compositions of polyalkylene glycol. The bottom layer is expected to form a non-uniform thickness coating and hence requires a second application. Such thick coatings tend to make the fabric stiff and uncomfortable to wear. U.S. Pat. No. 4,535,008 describes a fabric that is laminated to a microporous polyurethane (PU) layer. These fabrics, although believed to result in better breathability than the monolithic PU coated laminates, actually exhibit only moderate improvement.

Compared to ePTFE membranes, polyolefin-based porous films have an intrinsically higher surface energy (30 dynes/cm for PE, 19 dynes/cm for PTFE). They are also much easier to manufacture as films and can be made into novel block copolymers that have a wide variety of physical and mechanical characteristics. (International Patent Application Publication Nos. WO2005/090426 and WO2005/090427). Polyolefin films however have low moisture vapor transmission rates (MVTR), and may be used in applications in which low MVTR values are desirable, such as, for example, food packaging. Polyolefin films with higher MVTR values have been developed using a cavitating agent and then stretching the film biaxially to induce porosity into the films, such as those reported in U.S. Pat. Nos. 6,534,166 and 6,072,005. These membranes, described in U.S. Pat. No. 4,377,616, are known to have an excellent feel and drape. The porosity achieved may, however, be limited by the amount of cavitating agent because a higher concentration affects melt processability. The pore structure of such a film is also unsuitable for use as a membrane for waterproof fabrics.

What is needed is a strong, light weight, water-resistant polyolefin-based membrane that is easy to laminate and has an interconnecting pore structure to yield high MVTR.

### SUMMARY OF THE DISCLOSURE

A durable water- and oil-resistant, breathable microporous membrane exhibits good hand, feel, and drape. The thin microporous membrane is composed of a polymer matrix that includes a polyolefin material such as a low-density, medium-density, linear-low density, high density, and ultra-high molecular weight polyethylene; isotactic polypropylene; syndiotactic polypropylene; polymethyl pentene; or a mixture thereof. The structure of the microporous polymer matrix includes a bulk region between first and second major surfaces. The bulk region includes multiple interconnecting micropores extending between the first and second major surfaces to form a polyolefin membrane that exhibits inherent hydrophobicity and moisture vapor transmission properties. An applied fluorochemical treatment imparts oleophobicity to the polyolefin membrane. The fluorochemical treatment imparts a lower surface energy to the polyolefin membrane to provide oil and surfactant resistance to, and maintain moisture vapor transmission through, the microporous structure. Preferred embodiments of the microporous membrane also include an inorganic filler material such as calcium carbonate, to provide good hand, feel, and drape characteristics.

The fluorochemically treated microporous polyolefin membrane is bonded to a fabric material to form a fabric laminate with optimized permeability characteristics. An adhesive material forms the bond at an adhesive material interface that is patterned so as to occlude fewer than a majority of the interconnecting pores. Alternatively, the microporous polyolefin membrane may be laminated to a conventional fabric before application of the fluorochemical treatment.

One preferred application of the fabric laminate is that it forms part of an article of clothing, such as a jacket composed of, for example, nylon or polyester. The fabric material preferably has a major surface to which the polyolefin membrane is not bonded and to which a durable water and oil repellant (DWOR) has been imparted to ensure the jacket is waterproof in its entirety.

The disclosure also describes a method of applying fluorochemical treatment to the microporous polyolefin membrane and use of different amounts of fluorochemical treatment at the surfaces and in the bulk region of the membrane to establish oil resistance and breathability. These features are in addition to the excellent mechanical properties of the thin membrane.

Additional aspects and advantages will be apparent from the following detailed description of preferred embodiments, which proceeds with reference to the accompanying drawings.

### BRIEF DESCRIPTION OF THE DRAWINGS

FIG. 1 is a micrograph of a prior art commercially available microporous polyolefin membrane.

FIG. 2 is a micrograph of the membrane of FIG. 1, following fluorochemical treatment.

FIG. 3 is a schematic of a roller coating device used to apply a fluorochemical treatment to both sides of the membrane of FIG. 1.

FIG. 4 is a schematic diagram of a roller coating device used to apply a fluorochemical treatment to only one side of the membrane of FIG. 1.

FIG. 5A is a schematic fragmentary cross-sectional view of an Xscape® microporous polyolefin membrane in its manufactured state.

FIG. 5B is a schematic fragmentary cross-sectional view of an Xscape® microporous polyolefin membrane to which fluorochemical treatment has been applied to impart uniform oil resistance throughout the bulk region of the membrane.

FIG. 5C is a schematic fragmentary cross-sectional view of an Xscape® microporous polyolefin membrane to which fluorochemical treatment has been applied such that it forms a gradient within the bulk region of the membrane, imparting to the membrane oil resistance that decreases with depth of penetration into the bulk region.

FIG. 6 is a photograph of a jacket in which the disclosed fabric laminate can be incorporated to enhance water and oil resistance performance of the jacket in a wet environment.

### DETAILED DESCRIPTION OF PREFERRED EMBODIMENTS

In a preferred embodiment, a substrate in the form of a polyolefin membrane contains inorganic filler material such as fumed silica, precipitated silica, calcium carbonate, magnesium hydroxide, magnesium oxide, aluminum oxide, and the like that when laminated to fabric material provide a fabric laminate with microporosity, good feel, and drape. Other filler materials include carbon black for odor control and silver particles as an antibacterial agent. The inorganic filler material may contain surface treatments and is preferably incorporated into the membrane during an extrusion process. More specifically, the inorganic filler material is extruded in combination with UHMWPE and a plasticizer. The mixture is processed at temperatures above the melting point of the polyolefin to yield a thin film membrane. Subsequent removal of the plasticizer by an extraction process creates between the major surfaces of the thin membrane interconnecting micropores that provide overall fluid permeability to the membrane, resulting in a microporous structure throughout which inorganic filler material particles are dispersed.

The process disclosed relates to a method of uniformly treating such a microporous membrane with a coating solution comprising a fluorochemical composition and a suitable solvent. Fluorochemical compositions include perfluoroalkyl moieties with acryl or methacryl copolymers, phosphates, or urethane/urea oligomers. In this embodiment, the fluorochemical composition is first dissolved or dispersed in a solvent, then uniformly distributed on or throughout the polyolefin membrane, and finally dried to remove the solvent. The coated polyolefin membrane is sometimes further heat treated to affect its structure and performance characteristics (e.g., air permeability and oil resistance).

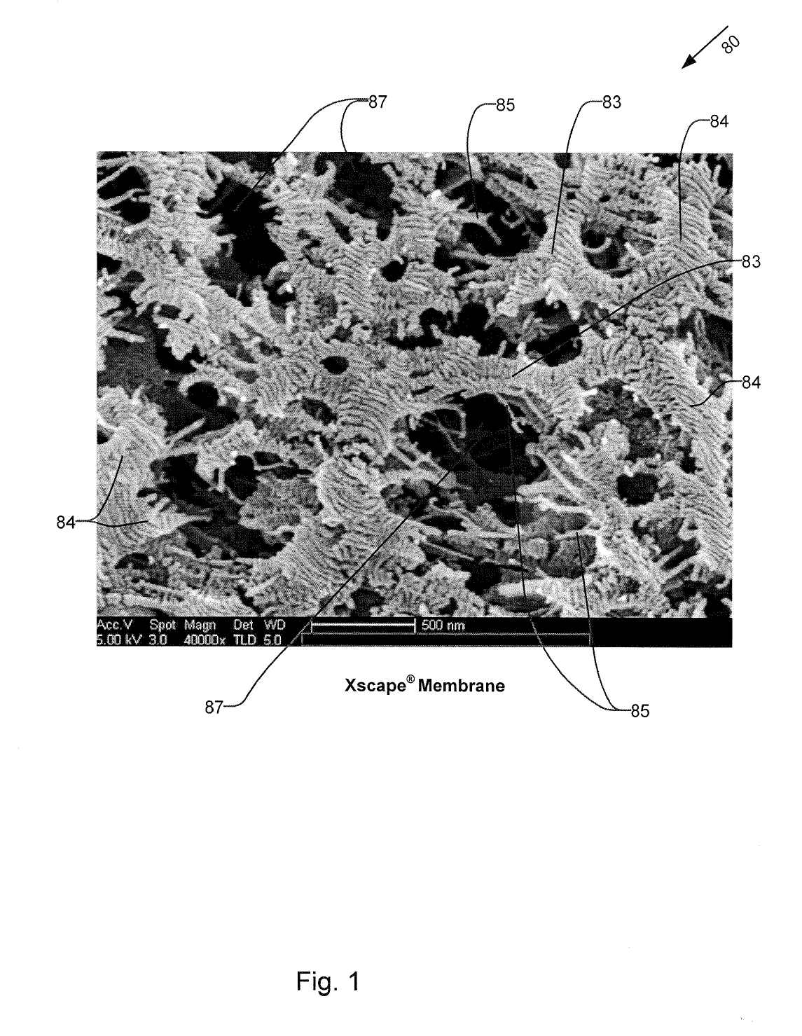

FIG. 1 is a micrograph of a microporous polyolefin membrane 80 sold under the product name Xscape® by Entek Membranes LLC, Lebanon, Oreg., which is the assignee of this patent application. With reference to FIG. 1, microporous membrane 80 is used as a substrate for testing the coating process with various coating formulas. Microporous membrane 80 comprises a polymer matrix that includes a fibrous polyolefin material 83 in which a filler material 84 is dispersed throughout individual polymer fibrils 85 and interconnecting micropores 87. Micropores 87 preferably have an average pore size of 0.01 μm-2 μm, and example pores shown in FIG. 1 measure approximately 0.5 μm. Microporous membrane 80 has between first and second major surfaces (only one shown in FIG. 1) a bulk region 89 that preferably has a total thickness of about 9 μm-20 μm.

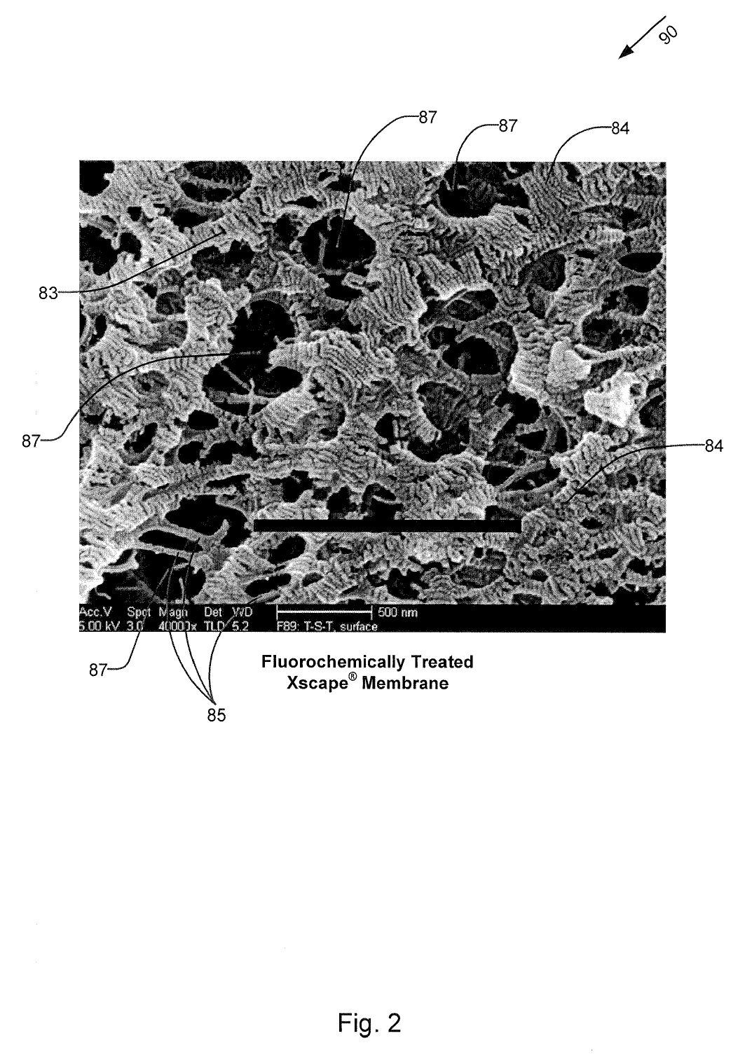

FIG. 2 is a micrograph of an Xscape® microporous membrane 90 following treatment with a penetrating fluorochemical coating. Although a desired oil resistance has been achieved, it is apparent from the micrograph that similar pores 87 visible in the untreated microporous membrane 80 of FIG. 1 are still evident in FIG. 2. Thus the oil resistant qualities of the material do not result in blocking off the pores, leaving a membrane that is simultaneously waterproof, oil-resistant, and breathable. The following is a description of the preparation and application of the fluorochemical treatment.

A 6.0% solids weight per unit volume (w/v) perfluoroalkyl acrylate co-polymer coating or treatment solution 92 is formed by mixing 1910 g of a commercial solvent grade fluoropolymer emulsion (Repearl® F611 available from MIC Specialty Chemicals, Iselin, N.J.) with 368 cc of odorless mineral spirits (OMS) and 700 cc of reagent-grade acetone in a large 4000 cc glass flask. By adding acetone to account for any negative volume of mixing, the final volume of the mixture is about 3500 cc, the mixing causing an endothermic reaction that cools the container by at least 5° C.-7° C. The mixture is then heated to maintain it at 25° C. while stirring, and a clear solution is formed.

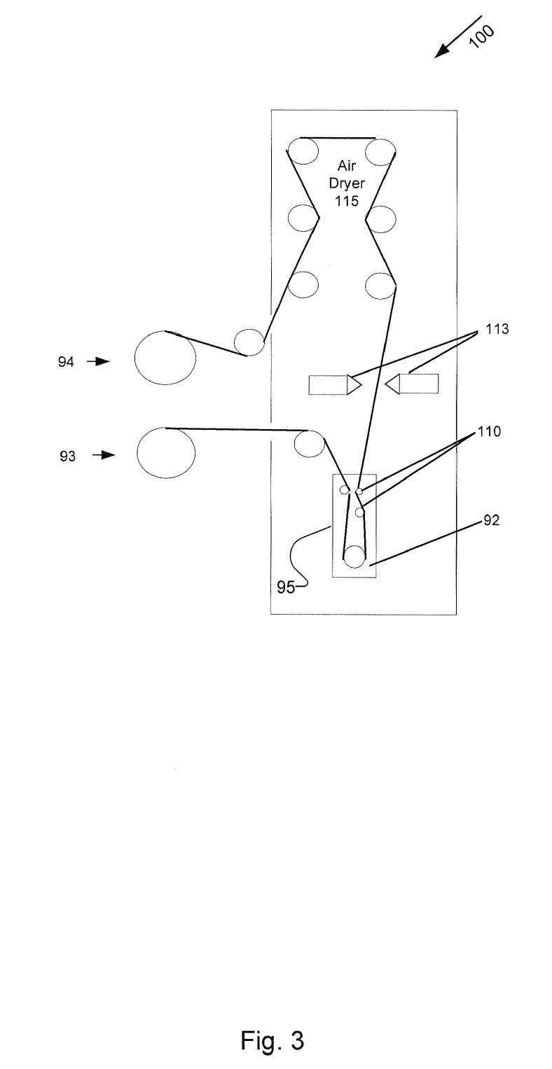

FIG. 3 shows an immersion coating machine 100 used to apply a fluorochemical treatment to form microporous membrane 90. With reference to FIG. 3, a 1500.0±50.0 mm wide sheet of microporous membrane 80 is taken from an unwind spindle 93, processed in immersion coating machine 100, emerges from coating machine 100 as microporous membrane 90, and is then rolled onto wind spindle 94. Within immersion coating machine 100, a treatment solution 92 is poured into a stainless steel dip tank 95. Microporous membrane 80 is continuously passed through treatment solution 92 at a rate of 0.5 m/min-5.0 m/min while membrane tension is closely monitored. When microporous membrane 80 turns translucent, thorough wetting of the pore structure by treatment solution 92 is indicated. Excess coating is regulated by use of one or more rotatable or stationary Meyer coating rods 110 positioned at the surface of microporous membrane 80. As microporous membrane 80 emerges from dip tank 95, tension is inherently applied in the machine direction and externally applied in the transverse direction. The coated web is then dried using air knives 113 from a heat gun source (not shown) at a temperature within the range 25° C.-140° C., preferably between 110° C.-140° C., for flash evaporation of the solvent from microporous membrane 80.

Two additional steps are then taken to activate the coating: a heat activation step followed by a polymer fibril relaxation step. During the heat activation step, the orientational order of fluorochemical molecules is reorganized by heating the sample to temperatures within a range of 70° C.-135° C., for durations within the range of 0.1-600 minutes or longer, and then cooling the sample to room temperature to enhance breathability and oil resistance, as measured using a standard American Association of Textile Chemists and Colorists test method, designated as AATCC 118.

The heat activation step is carried out in air or in a nitrogen dryer 115, for either a thin membrane or for a whole coated roll. Longer activation times are required for treatment of rolls. Air permeability is determined using a Gurley® densometer model 4340, which measures the time in seconds (s) for 100 cc of air to pass through a 6.45 cm² membrane at an applied pressure of 1215 Pa. The final Gurley values are dependent on the fluorochemical composition and heat activation conditions employed, in addition to the porosity of the original untreated membrane. In the fibril relaxation step, the strained fibrils are stretched to further increase breathability.

As verified by more than two hundred readings, these two activation steps, either by themselves or in combination, in any order or multiplicity, ensure that the final membranes exhibit good oil resistance and a high moisture vapor transmission rate (MVTR), irrespective of their initial values. Whereas initial MVTR values range from 5000-35000 gm/m²/24 hr, all the coated and activated membranes tested exhibited an MVTR>70000 gm/m²/24 hr, and most were about 90000 gm/m²/24 hr. Oil resistance greater than 5 was achieved on both sides of the membrane in all cases. The applied fluorochemical treatments described in the following examples are believed to result from liquid crystalline polymer behavior in which side-chain or backbone molecular orientation order may be modified using a range of energy sources. Activation sources such as heat, pressure, physical strain, light, UV radiation, corona treatment, electric or magnetic field may therefore also be used alone or in combination to achieve the desired oil resistance and MVTR.

The following examples use either the Xscape® microporous membrane of FIGS. 1 and 2, made from UHMWPE, HDPE, and inorganic filler material, CaCO₃, or an alternative microporous membrane product Teklon® made from UHMWPE and HDPE. The Teklon® membrane preferably has an average pore size of 0.01 μm-1 μm, is preferably about 9 μm-20 μm thick, and contains no inorganic filler.

### Example 1

An Xscape® microporous membrane was treated with a coating made with the Repearl® F611-based formula, and using the process, described above. Typical coat weights were about 1.5±0.7 g/m². A 200 m coated roll was nominally heat-treated at 100° C. for three hours and then measured to determine oil resistance and air permeability. The membrane, as-coated, exhibited poor oil resistance (values of 0-1 based on the AATCC test method); however, the values increased to greater than 5 after heat activation. (Generally, oil resistance values are considered insubstantial in the 0-1 range, and substantial when they exceed 5.) Representative Gurley values of 1000-2500 s were obtained for as-coated samples, while substantially lower values of 70-150 s were obtained after heat activation.

The coated membrane did not exhibit oil resistance when the sample temperature was maintained above 70° C. and the sample attained orientational ordering and consequent oleophobicity when cooled back to the ambient temperature. This phenomenon is important during lamination of the membrane with a fabric using, for example, a hot melt adhesive.

### Example 2

In this example, the coating solution was a combination of 1910 g of Repearl® F611 with 1070 cc of reagent-grade acetone only (i.e., the same trial as in Example 1, without the odorless mineral spirits). The resulting oil repellency was still greater than 5, and the membrane had MVTR>94000 gm/m²/24 hr.

In another embodiment, the reagent grade acetone was replaced with reagent grade hexane. The oil repellency still exceeded 5.

### Example 3

In this example, the process parameters (membrane material, coating method, and activation procedure) described above were repeated using fluoropolymer solutions with concentrations of 2.5, 5.0, 6.9, and 7.5% w/v. The following table summarizes the coat weight and oil resistance data corresponding to the different concentrations tested.

TABLE 1
Summary of physical properties of F611 coated
membranes as a function of solution concentration

Fluoropolymer
conc. (% w/v)

| | 2.5 | 5.0 | 6.9 | 7.5 |
|---|---|---|---|---|
| Coat weight (g/m²) | 1.11 | 1.48 | 1.49 | 1.28 |
| Oil resistance | 5 | 6 | 6 | 6 |

### Example 4

In this example, a Teklon® membrane was substituted for the Xscape® membrane. The solution and activation procedures described in Example 1 were used to treat the membrane. A coat weight of 2.83 g/m² was obtained with an average air permeability Gurley value of 280 s, and an oil repellency of 5.

### Example 5

The microporous membrane, Xscape®, was again used as in Examples 1-3. A 4.7% w/v solution of perfluoroalkyl moiety with urethane/urea oligomer was formed by mixing 748 g of a commercial fluoropolymer emulsion such as Repearl® F89 (available from MIC Specialty Chemicals, Iselin, N.J.), with 2154 cc of deionized water (DI) and 875 cc of reagent-grade isopropyl alcohol (IPA) in a large 4000 cc glass flask. The volume of the final mixture was 3500 cc with a water/IPA ratio of approximately 3:1. The dispersion was stable, and no precipitate was observed during the solution preparation step. Isopropyl alcohol decreases the solution surface tension and relative contact angle to allow wetting and coating the pore structure.

The microporous membrane was continuously passed through F89 solution in a dip tank, and the solvent was evaporated using air knives at 110° C.-140° C. The treated membrane was then heat activated as explained above. Representative properties of the microporous film include coat weights of 1.0±0.5 g/m², a Gurley value less than 100 s, and oil resistance greater than 7.

### Example 6

A 300 mm wide laminate was prepared by adhesive dot lamination of an Xscape® membrane to a Nylon 66 fabric having a 70 g/m² basis weight. The fabric laminate still exhibited good air permeability after lamination. The laminate was treated by continuously passing it through a tank filled with fluorochemical solution such that the laminate is completely wet as it exits the tank. Two different solutions were used: 5.0% w/v fluoropolymer (Repearl® F611) in an 80/20 volume ratio of OMS/acetone and a 4.7% w/v fluoropolymer (Repearl® F89) in a 75/25 volume ratio of DI water/IPA. The wet laminate is dried using air knives at 110° C.-140° C., and then further heat activated. Table 2 below shows the laminate properties after coating and heat activation treatment.

TABLE 2
Summary of physical properties
of coated and heat activated laminates

| Membrane side | |
|---|---|
| Before | After |
| activation | activation |

| Coating solution | Gurley (s) | Oil | Gurley (s) | Oil |
|---|---|---|---|---|
| F611 fluoropolymer | 3230 | 6 | 242 | 7 |
| F89 fluoropolymer | 1094 | 1 | 150 | 8 |

### Example 7

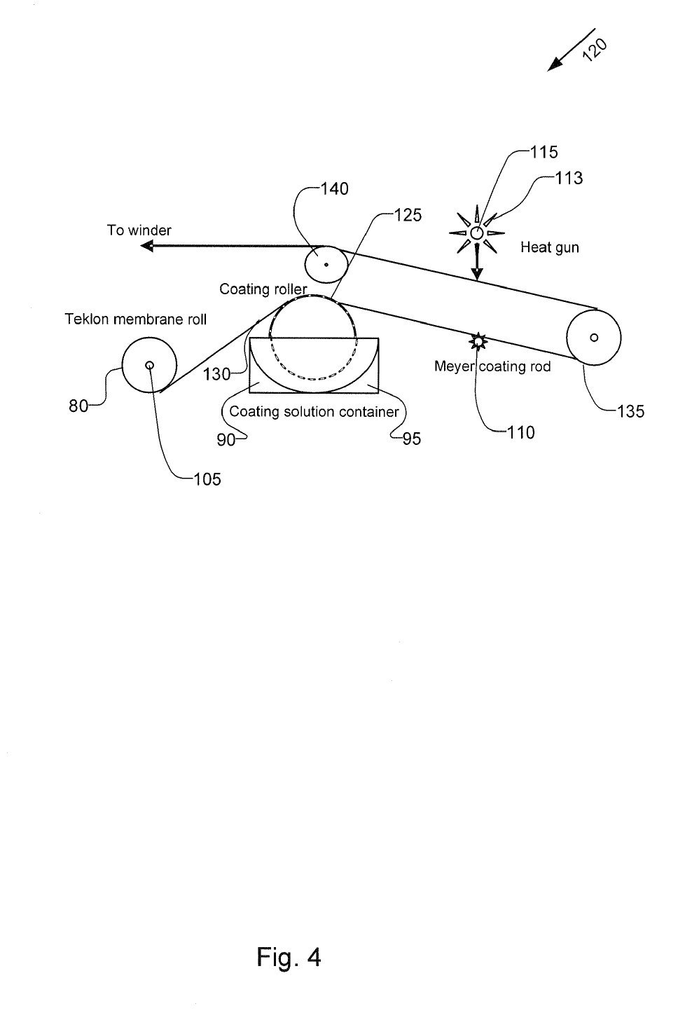

This example used a 300 mm wide Teklon® microporous membrane having a Gurley value of about 250 s. The membrane was coated on only one side by using a single-side roller coating apparatus 120 as shown in FIG. 4. A sheet of microporous membrane 80 is rolled onto an input spindle 105, and is continuously passed over a coating roller 125. Coating roller 125 transfers treatment solution 92 from dip tank 95 to only the underside 130 of microporous membrane 80. Excess coating is regulated by use of one or more rotatable or stationary Meyer coating rods 110 positioned at the surface of microporous membrane 80, thus ensuring an even coating across the membrane, and removing any excess solution. Tension is applied in the machine direction by additional rollers 135. The coated web is then dried using air knives 113 from a heat gun source 115 at a temperature within the range 25° C.-140° C., preferably between 110° C.-140° C., for flash evaporation of the solvent from microporous membrane 80. After drying, microporous membrane 80 is wound onto an output spindle 140.

The solution described in Example 5 was used for coating with a coat speed of approximately 5-15 m/min. The as-coated sample had a Gurley value of approximately 2000 s and no oil resistance. After activation by heating at 80° C.-120° C. for 0.1 min-60 min, the membrane displayed oil resistance of 5 on both sides, in spite of using a single side coating. After heating, Gurley values were about 500 s.

### Example 8

A fabric laminate as described in Example 6 was coated using the method described in Example 7. First, only the membrane side was coated. The as-coated oil resistance for membrane and fabric sides was zero (AATCC 118 method). The coated laminate was then heat-activated at 80° C.-120° C. for 0.1 min-60 min. After activation, the membrane side exhibited an oil resistance of 7 while the oil resistance of the fabric side remained at zero. A Gurley value of about 275 s was obtained for the coated laminate after activation.

When only the fabric side was coated, similar to the description in Example 6, it exhibited an oil resistance of 7 after activation while the membrane showed no oil resistance. The Gurley value was about 100 s after activation.

### Example 9

A 150 mm wide microporous Xscape® membrane was used as a substrate for testing the coating process. A 5.0% w/v solution was formed by mixing 250 g aqueous grade fluoropolymer emulsion (ST-50 available from MIC Specialty Chemicals, Iselin, N.J.), with 475 cc of reagent grade isopropanol (IPA) and 287 cc of deionized water (DI water) in a 2500 cc glass flask. With reference again to FIG. 3, the solution was poured into dip tank 95 attached to immersion coating machine 100 with a dryer length of about 10 m. Meyer rods 110 were used on each side to regulate the amount of coating solution the membrane picks up. Microporous membrane 80 wetted instantly upon contacting treatment solution 92 and was dried at temperatures of 25° C.-120° C. for solvent evaporation. Upon passing through the dryer chamber, microporous membrane 80 had oil resistance of 4 on one side and 1 on the other side. After a heat activation process as described in Example 1, the oil resistance increased to more than 6 on both sides. Gurley values for this trial were about 1000 s because a smaller processing line was used with less scraping of the membrane by the Meyer coating rods. MVTR values approaching those reported for activated membranes in Example 1 are achievable with the coating solution used in this example.

### Example 10

In this example, a 300 mm wide laminate was used as described in Example 6. A coating solution similar to that used in Example 5 was modified by addition of a thermoplastic nonionic cross-linking agent that increases the durability of a fluoropolymer finish (TP-10 available from MIC Specialty Chemicals, Iselin, N.J.). A 4.3% w/v solution of perfluoroalkyl moiety with urethane/urea oligomer (Repearl® F89) was formed by mixing 488.6 g of commercial fluoropolymer emulsion with 1455 cc of deionized water (DI) and 590 cc of reagent-grade isopropyl alcohol (IPA) in a large 4000 cc glass flask. Then, 62.5 g of the cross-linking agent was added slowly to the solution while stirring is continuously performed.

The laminate was coated using immersion coating machine 100 described in Example 9. The coated laminate was subjected to heat activation as described above, and oil resistance greater than 4 was achieved for both the fabric and the membrane. After 25 washes using AATCC 135-2004 Option 1, a nearly 30% improvement was obtained for the hydrostatic head pressure values (as measured under JIS L1092:1998 6.1B method) for the cross-linking agent coated fabric as compared to one without the agent.

### Example 11

A 4.3% w/v solution of perfluoroalkyl moiety with urethane/urea oligomer (Repearl® F89) was formed by mixing 488.6 g of commercial fluoropolymer emulsion with 1455 cc of deionized water (DI) and 590 cc of reagent-grade isopropyl alcohol (IPA) in a large 4000 cc glass flask. The solution was sprayed from a distance of 250 mm-350 mm onto a 300 mm wide fabric laminate (as referred to in Example 6) using a commercially available paint sprayer. The fabric laminate was taped at its edges onto a wooden board during the spray coating process. The coated fabric was then heat activated as described in Example 1 and tested for air permeability and oil resistance.

The following table lists the spray coating results on the membrane side.

| # of spray coats | Avg. Gurley (s) | Oil resistance |
|---|---|---|
| single coat | 143 | 4 |
| double coat | 143 | 6 |
| >3 coat | 1910 | 7 |

### Example 12

A solution as described in Example 11 was used to coat a Teklon® microporous membrane during its manufacturing process. Open cell foam attached to a 300 mm aluminum rod was wet with the solution and kept in contact with a moving web of the microporous membrane. The membrane turns translucent upon contacting the coating solution, indicating wetting of the web. The coated membrane then enters a transverse direction orientation machine (tenter) that is operated at 100° C.-135° C. and is divided into four zones. Zones 1-4 stretch the membrane transversely to approximately 30%, 65%, 65%, and 65%, respectively, above the initial width of the membrane. Edge holder clips on a rotating chain ensure that the membrane is taut as it travels through the tenter. Finally, the treated porous film is continuously wound onto cardboard rolls at a constant tension.

Treated regions of the sheet were examined for oil resistance (as per AATCC 118) on both sides of the membrane. The coated side exhibited an oil resistance value of 8, while the other side of the same membrane exhibited zero oil resistance. In this way, a gradient in oil resistance was achieved through the thickness direction, which oil resistance gradient may be beneficial in further lamination processes of the membrane to a fabric.

In another trial of this example, a 1.0% w/v solution of perfluoroalkyl moiety with urethane/urea oligomer (Repearl® F89) was formed by mixing 45.5 g of commercial fluoropolymer emulsion with 730 cc of deionized water (DI) and 250 cc of reagent-grade isopropyl alcohol (IPA) in a 2000 cc glass flask. This solution was used to coat a continuously moving Teklon® membrane and then passed through a tenter as described above. Coated regions of the sheet were then examined for oil resistance (as per AATCC 118) on both sides of the membrane. The treated side exhibited an oil resistance value of 5, while the other side of the same membrane exhibited zero oil resistance. The starting Teklon® membrane had a Gurley value of approximately 450 s, while the treated sample had an average value of 700 s.

### Example 13

An acrylic transfer adhesive deposited on one side of a polycoated release liner, Unifilm U837, available from Scapa North America, of Windsor, Conn., was adhered by hand pressure to an Xscape® microporous membrane. The membrane was previously coated and treated as described in Example 5 and had a Gurley value of about 150 s. The release liner was removed from the membrane-adhesive-release liner composite, and the acrylic adhesive was attached by light hand pressure to a nylon fabric that had a Gurley value of less than 1 s. The fabric laminate was then heat treated at 100° C. for 10 minutes to achieve a good lamination bond, especially between the coated membrane and adhesive. The fabric laminate thus formed had a Gurley value of more than 25000 s, indicating that uniform, continuous coverage of the adhesive between the fabric and the membrane severely limits air permeability. Use of the release liner enables roll-up of the membrane-adhesive-release liner composite, and thereby facilitates storage and transportation of large sheets of the composite, and easy unrolling and cutting of the composite in the production of a fabric laminate.

In another embodiment of the above described lamination method, a patterned medical grade acrylic transfer adhesive deposited on a polycoated release liner, such as Rx734U, available from Scapa North America, was adhered by hand pressure to an Xscape® membrane. The membrane was previously coated and treated as described in Example 5. The adhesive pattern can be described as a honeycomb structure with a cell width of about 3 mm and wall thickness of 1 mm. A lamination assembly as described in the previous paragraph was formed from adhesion of the patterned acrylic with the membrane (Gurley value approximately 150 s) and a nylon fabric (Gurley value less than 1 s). The fabric laminate thus formed had a Gurley value of only 170 s, indicating high air permeability, and was maintained with patterned coverage of the adhesive between the fabric and the membrane. This example clearly shows that the lamination strength and Gurley value of the overall fabric laminate is dependent on the adhesive type and pattern used. An adhesive pattern that occludes no more than about 20%-30% of the micropores provides good air permeability.

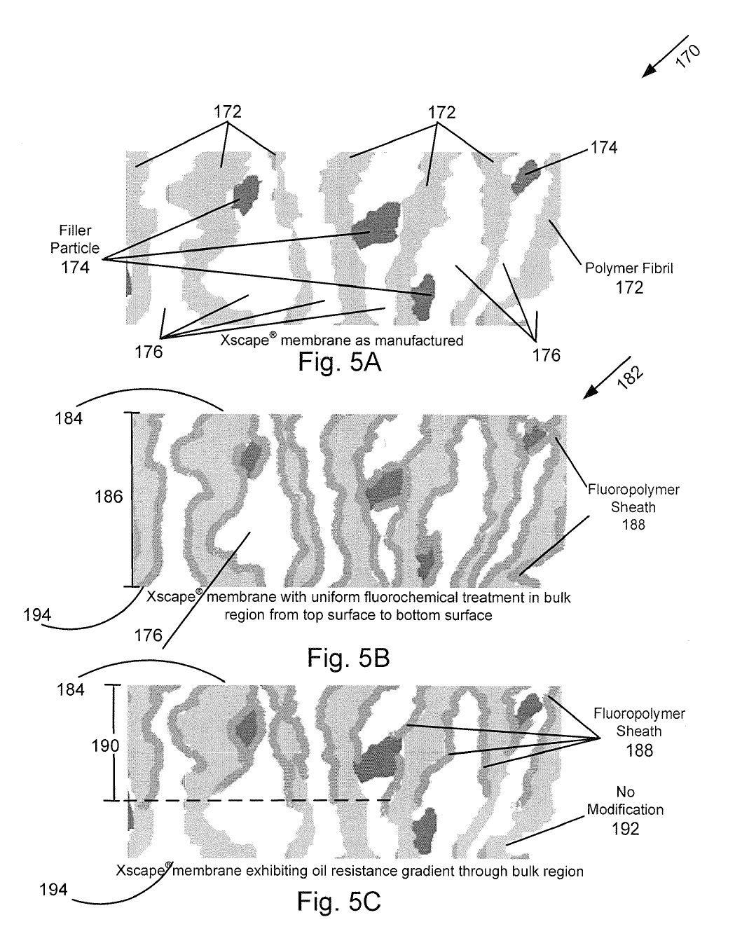

Performance of the treated microporous membranes in the examples above is consistent with the following model depicted in the concept schematic drawings shown in FIGS. 5A, 5B, and 5C.

With reference to FIG. 5A, an untreated microporous polyolefin membrane 170 includes constituents in the form of polymer fibrils 172, inorganic filler particles 174, and multiple interconnecting micropores 176.

With reference to FIG. 5B, throughout the bulk region, the fluoropolymer is distributed evenly among the internal components of the porous structure, with fluoropolymer sheaths 180 having substantially uniform thickness. It is the high degree of porosity of specialized polyolefin membrane 170, and its moisture vapor transmission properties, combined with a lower surface energy contributed by the fluoropolymer treatment that cooperate to achieve the final membrane structure 182 exhibits desirable water-resistant, oil-resistant qualities without sacrificing breathability, thus yielding a membrane suitable for use in fabric laminate products.

With reference to FIG. 5C, when an upper surface 184 of membrane 170 is treated with a fluoropolymer solution, the solution penetrates porous bulk region material 186, internally coating and forming a fluoropolymer sheath 188 around individual polymer fibrils 172 and filler particles 174 located within a depth 190 below top (treated) surface 184 of the bulk material. Near the boundary of depth 190 fluoropolymer sheath 188 tapers, indicating the presence of a fluoropolymer concentration gradient within the bulk region, and thus leaving unmodified the bottom portion 192 of polyolefin membrane 170. Subsequent heating causes thermally activated migration throughout the bulk material, decreasing the concentration gradient, and thereby effectively rearranging fluoropolymer sheaths 188 until the solution permeates the entire thickness of bulk region 186 to a lower surface 194 of polyolefin membrane 170 without blocking micropores 176.

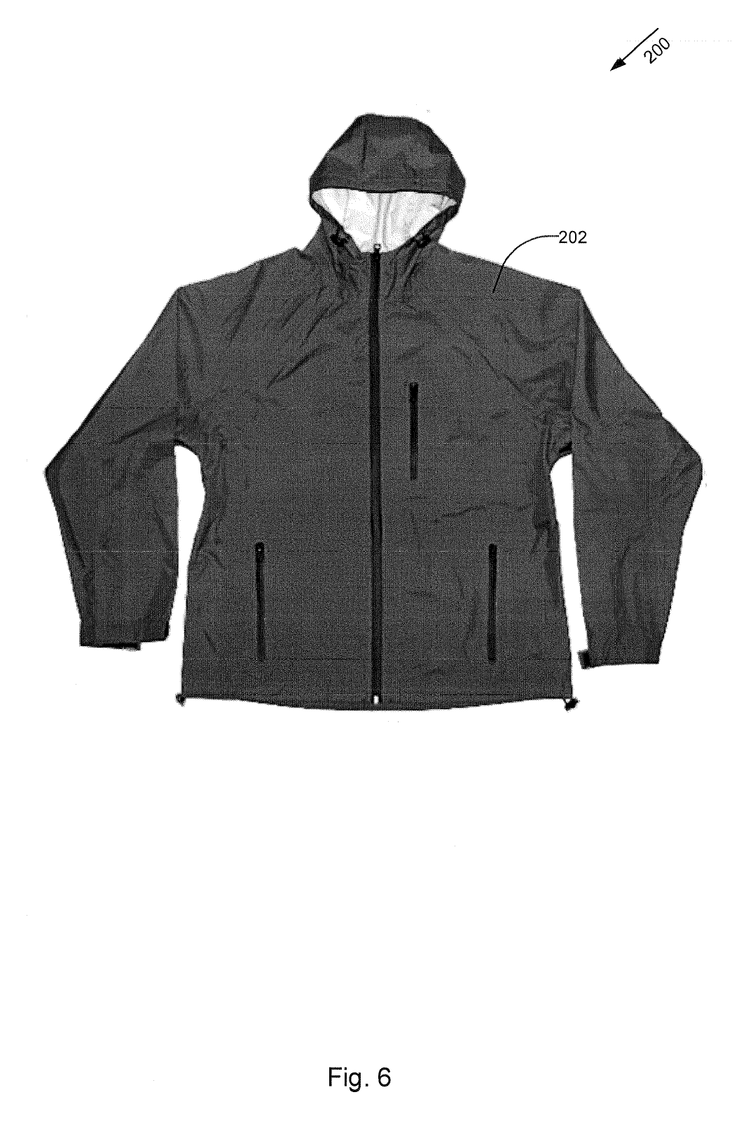

FIG. 6 shows a jacket 200 as an example of an article of clothing of which any one of the disclosed fabric laminates can be a component part. Jacket 200 has an outer fabric surface 202 to which a durable water and oil repellant (DWOR) treatment may be applied to enhance the water and oil resistance of jacket 200. The polyolefin membrane is laminated to the inner fabric surface (not shown) of jacket 200. The DWOR treatment may be performed on the fabric either before or after lamination of the polyolefin membrane to the fabric.

It will be obvious to those having skill in the art that many changes may be made to the details of the above-described embodiments without departing from the underlying principles of the invention. The scope of the present invention should, therefore, be determined only by the following claims.

1. A durable water- and oil-resistant, breathable microporous membrane, comprising:
a polymer matrix including polyolefin material and having between first and second major surfaces a bulk region that includes a microporous structure of multiple interconnecting micropores extending between the first and second major surfaces to form a polyolefin membrane, the polyolefin membrane exhibiting inherent hydrophobicity and moisture vapor transmission properties; and
a fluorochemical treatment applied to impart oleophobicity to the polyolefin membrane, the fluorochemical treatment contributing a low surface energy to the polyolefin membrane to provide oil and surfactant resistance to, and maintain moisture vapor transmission through, the microporous structure.

2. The microporous membrane of claim 1, in which the polymer matrix of the polyolefin membrane includes polyethylene.

3. The microporous membrane of claim 1, in which the polymer matrix of the polyolefin membrane includes ultrahigh molecular weight polyethylene.

4. The microporous membrane of claim 3, in which the polymer matrix of the polyolefin membrane includes a mixture of ultrahigh molecular weight polyethylene and high density polyethylene.

5. The microporous membrane of claim 1, further comprising an inorganic filler material.

6. The microporous membrane of claim 5, in which the inorganic filler material is selected from a group consisting of fumed silica, precipitated silica, calcium carbonate, magnesium hydroxide, magnesium oxide, and aluminum oxide.

7. The microporous membrane of claim 1, in which the fluorochemical treatment is substantially uniformly distributed throughout the bulk region.

8. The microporous membrane of claim 1, in which the bulk region exhibits a fluorochemical treatment gradient profile between and including the first and second major surfaces.

9. The microporous membrane of claim 8, in which the applied fluorochemical treatment resides in greater and lesser amounts on, respectively, the first and second major surfaces.

10. The microporous membrane of claim 1, in which the applied fluorochemical treatment resides in greater and lesser amounts on, respectively, the first and second major surfaces, and in which the second major surface carries an adhesive material distributed in a pattern that occludes fewer than a majority of the interconnecting pores.

11. The microporous membrane of claim 10, in which the lesser amount is insubstantial.

12. The microporous membrane of claim 10, in which the greater and lesser amounts are substantial.

13. The microporous membrane of claim 9, in which a releasable liner material covers the patterned adhesive material.

14. The microporous membrane of claim 1, in which the applied fluorochemical treatment resides in greater and lesser amounts on, respectively, the first and second major surfaces, and in which an adhesive material bonds a fabric material to the second major surface to form a fabric laminate.

15. The microporous membrane of claim 14, in which the lesser amount is insubstantial.

16. The microporous membrane of claim 14, in which the adhesive material forms the bond at an adhesive material interface that is patterned so as to occlude fewer than a majority of the interconnecting pores.

17. The microporous membrane of claim 14, in which the fabric laminate forms part of an article of clothing.

18. The membrane of claim 14, in which the fabric material includes nylon.

19. The membrane of claim 14, in which the fabric material includes polyester.

20. The microporous membrane of claim 14, in which the fabric material has a major surface to which the polyolefin membrane is not bonded and to which a durable water and oil repellant (DWOR) has been imparted.

21. The microporous membrane of claim 1, further comprising a carbon black filler material for odor control.

22. The microporous membrane of claim 1, further comprising silver particles functioning as an antibacterial agent.
